(19) United States
(12) Patent Application Publication
(10) Pub. No.: US 2012/0166368 A1
(43) Pub. Date: Jun. 28, 2012

(54) APPARATUS FOR GENERATING A PROBABILITY GRAPH MODEL USING A COMBINATION OF VARIABLES AND METHOD FOR DETERMINING A COMBINATION OF VARIABLES

(76) Inventor: Yeo-Jin Kim, Hwaseong-si (KR)

(21) Appl. No.: 13/166,421

(22) Filed: Jun. 22, 2011

(30) Foreign Application Priority Data
Dec. 24, 2010 (KR) 10-2010-0134893

(51) Int. Cl. G06F 15/18; G06N 5/04

(52) U.S. Cl. 706/12; 706/52

(57) ABSTRACT

An apparatus and method for generating a probability graph model are provided. When generating a probability graph model using variable combinations, a variable combination that has a small amount of information may not generated, thereby reducing the amount of computation. The apparatus may acquire independent variables including a plurality of input variables corresponding to context information and an output variable corresponding to an inference result, and may determine a variable combination that is to be generated, based on the amount of information of each of variable combinations with respect to the output value, in which the variable combination is defined based on combining of the input variables.

### CROSS-REFERENCE TO RELATED APPLICATION(S)

This application claims the benefit under 35 U.S.C. §119(a) of Korean Patent Application No. 10-2010-0134893, filed on Dec. 24, 2010, in the Korean Intellectual Property Office, the entire disclosure of which is incorporated herein by reference for all purposes.

### BACKGROUND

1. Field

The following description relates to an apparatus and method for generating of a probability graph model.

2. Description of the Related Art

Smart devices provide users with various types of services. Along with the abrupt increase of diversity in the services of smart devices, users have expressed an increased demand for desired types of services based on the situation and the surrounding environment.

Context information in the real world is very uncertain. A user may probabilistically determine the most desired service at his/her current location and/or situation. Such a probabilistic determination may be achieved using a probability graph model that is obtained by modeling context information for each situation and a desired service that is suitable for the context information.

The probability graph model may be manually designed by a user or may be automatically designed through machine learning. The manually designing method has difficulty in automatically updating a probability graph model once the probability graph model has been fixed. The automatic design method enables a probability graph model to be automatically updated but has limitations in covering all the uncertain context information of the real world.

In addition, most data in the real world is provided in the form of stream data. The stream of data varies with time, and requires real time characteristics. Accordingly, it is difficult to apply a conventional probability graph model to the stream data in the real world.

### SUMMARY

In one general aspect, there is provided an apparatus for generating a probability graph model, the apparatus including an independent variable acquiring unit configured to acquire independent variables including a plurality of input variables corresponding to context information and an output variable corresponding to an inference result, and a variable combination determining unit configured to determine a variable combination that is to be generated, based on an amount of information of each of the variable combinations with respect to the output value, in which the variable combination is defined based on combining of the input variables.

The apparatus may further comprise a first matrix generating unit configured to generate a first matrix including stream data of the independent variables, a second matrix generating unit configured to generate a second matrix by selectively combining stream data of first variables in the first matrix which are included in the determined variable combination, and a graph generating unit configured to generate a probability graph model using the second matrix.

The variable combination determining unit may determine the variable combination that is to be generated by calculating an entropy of each of the input variables with respect to the output variable and comparing the calculated entropy with a threshold value.

The variable combination determining unit may determine the variable combination that is to be generated by calculating a first entropy of each of the input variables with respect to the output variable, calculating a second entropy of a variable combination of the input variables with respect to the output variable, and comparing the calculated first entropy with the calculated second entropy.

The variable combination determining unit may determine the variable combination that is to be generated based on a similarity between a first conditional probability distribution of a first input variable with respect to the output variable and a second conditional probability distribution of a second input variable with respect to the output variable.

The variable combination determining unit may determine the similarity based on a position of a maximum probability value of the first conditional probability distribution and a position of a maximum probability value of the second conditional probability distribution.

In another aspect, there is provided a method for determining a variable combination used to generate a probability graph model, the method including receiving independent variables including a plurality of input variables corresponding to context information and an output variable corresponding to an inference result, and determining a variable combination that is to be generated, based on an amount of information of each of the variable combinations with respect to the output variable, in which the variable combination is defined based on combining of the input variables.

The method may further comprise generating a first matrix including stream data of the independent variables, generating a second matrix by selectively combining stream data of first variables in the first matrix which are included in the determined variable combination, and generating a probability graph model by use of the second matrix.

During the determining of the variable combination that is to be generated, entropy of each of the input variables with respect to the output variable may be calculated and the calculated entropy may be compared with a threshold value.

During the determining of the variable combination that is to be generated, a first entropy of each of the input variables with respect to the output variable may be calculated, a second entropy of a variable combinations of the input variables with respect to the output variable may be calculated, and the calculated first entropy may be compared with the calculated second entropy.

During the determining of the variable combination that is to be generated, the desired variable combination may be determined based on a similarity between a first conditional probability distribution of a first input variable with respect to the output variable and a second conditional probability distribution of a second input variable with respect to the output variable.

The variable combination that is to be generated may be determined based a position of a maximum probability value of the first conditional probability distribution and a position of a maximum probability value of the second conditional probability distribution.

In another aspect, there is provided a terminal for inferring an application to be executed by a user of the terminal, the terminal including a receiver configured to receive input variables corresponding to context information about the terminal and an output variable corresponding to an inferred application recommended based on the context information, and a determining unit configured to determine a combination of the input variables to be used in a probability graph model based on the amount of information of each corresponding variable combination.

The terminal may further comprise a graph generator to generate the probability graph model based on the determined combination of input variables and to display the probability graph model.

The determining unit may determine a combination of input variables based on the entropy of each input variable with respect to the output variable.

The determining unit may determine a combination of input variables based on the similarity of a conditional probability distribution of each input variable with respect to the output variable.

Other features and aspects may be apparent from the following detailed description, the drawings, and the claims.

### BRIEF DESCRIPTION OF THE DRAWINGS

FIG. 1 is a diagram illustrating an example of an inference apparatus.

FIG. 2 is a diagram illustrating an example of variables.

FIG. 3 is a diagram illustrating an example of an apparatus for generating a probability graph model.

FIG. 4 is a diagram illustrating an example of a combination determining unit.

FIGS. 5A and 5B are diagrams illustrating examples of estimating the amount of information.

FIGS. 6A to 6D are additional diagrams illustrating examples of estimating the amount of information.

FIG. 7 is a diagram illustrating an example of a method for determining a variable combination used to generate a probability graph model.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

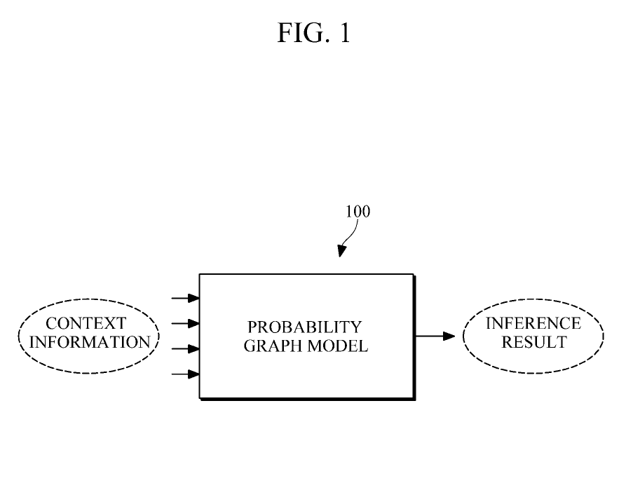

FIG. 1 illustrates an example of an inference apparatus.

Referring to FIG. 1, inference apparatus 100 generates an inference suitable for a situation using a probability graph model. The probability graph model may be an inference model that represents a probabilistic relationship between the context information and the inference result in the form of a graph.

For example, the inference apparatus 100 may be applied to a terminal that executes various types of applications. For example, the terminal may be a computer, a mobile terminal, a smart phone, a laptop computer, a personal digital assistant, a tablet, an MP3 player, a home appliance, a television, and the like.

If the inference apparatus 100 is applied to a smart phone, the context information may be information about a context, such as the time and location at which the smart phone is used, and the inference result may be an application that is recommended for the time and the location. In addition, the inference apparatus 100 may be applied to various fields that use an inference result that varies with the situation, for example, a biological system for discovering a gene expression mechanism, a healthcare system for suggesting a suitable remedy for the behaviour pattern of each patient, a teaching system for suggesting a suitable teaching method for the behaviour pattern of each user, and the like.

The inference apparatus 100 may generate a probability graph model. For example, the probability graph model may be generated based on variables that correspond to the context information and the inference result. The inference apparatus 100 may receive, via a receiver, various input variables corresponding to context information about the terminal. The inference apparatus 100 may generate a probability graph model by mapping each variable to nodes of a probability graph and by mapping a probabilistic relationship between variables to a link between the nodes.

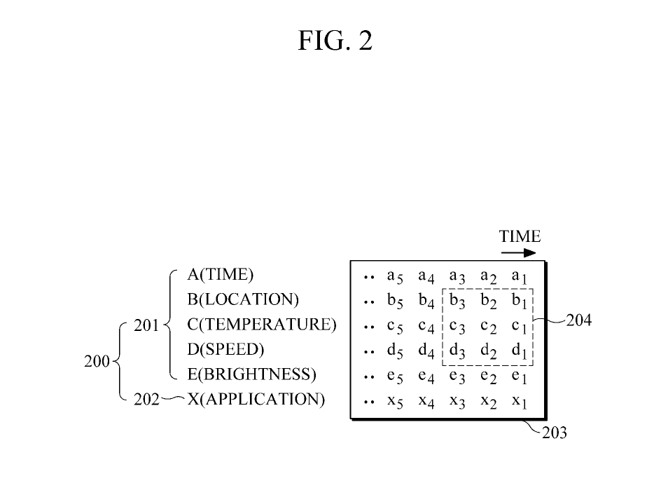

FIG. 2 illustrates an example of variables.

Referring to FIG. 2, variables 200 include a plurality of input variables 201 and an output variable 202. Each of the variables 200 is an independent variable. The input variable 201 corresponds to context information. The output variable 202 corresponds to an inference result. In this example, the input variable 201 include a time variable A, a location variable B, a temperature variable C, a speed variable D, and a brightness variable E. The output variable 202 includes an application variable X.

As shown in FIGS. 1 and 2, the inference apparatus 100 may receive stream data 203 of the input variable 201 and the output variable 202. The inference apparatus 100 may receive observation values of various types of sensors. For example, the sensors may include a hardware sensor. The hardware sensor may sense various information, for example, time, location, temperature, speed, brightness, adjacency, and the like. As another example, the sensor may include a software sensor. The software sensor may sense various information, for example, schedules, e-mail, messages, call history, internet news, social network information, and the like.

For example, the inference apparatus 100 may measure the type of an application that is being executed in a system using a measurement value of a software sensor. In addition, while the corresponding application is being executed, the inference apparatus 100 may periodically measure and store various information such as the time, location, temperature, speed, and brightness, which are related to the system that is executing the application, and the proximity between a user and the system.

The inference apparatus 100 may estimate the probabilistic relationship among the stream data 203 of the variables 200, and generate a probability graph model based on the estimated probability relationship. For example, the inference apparatus 100 may map each of the input variables 201 to an input node of a graph, may map each of the output variables 202 to an output node of a graph, and may determine whether to generate a link between the input node and the output node based on the probabilistic relationship between the input node and the output node, thereby generating a probability graph model.

The inference apparatus 100 may generate a probability graph model using the variable combination. For example, the inference apparatus 100 may generate variable combinations by combining stream data of the input variables 201 from among the stream data 203 of the variables 200. The inference apparatus 100 may map each of the generated variable combinations to an input node of a graph, may map each of the stream data of the output variables 202 to an output node of a graph, and may determine whether to generate a link between the input node and the output node based on the probabilistic relationship between the input node and the output node, thereby generating a probability graph model.

In generating the probability graph model using the variable combination, the inference apparatus 100 may determine whether to generate a corresponding variable combination based on the amount of information of the corresponding variable combination. As the variable combination is generated, the number of nodes of a graph may be increased based on the generated variable combination. If the amount of information of a variable combination is not great, it may not be desirable to calculate and estimate the probabilistic relationship between nodes corresponding to the variable combination. In this example, a variable combination that has only a small amount of information may not be generated, thereby reducing the amount of computation.

The inference apparatus 100 may store a generated probability graph model, and generate an inference result that is suitable for a situation using the stored probability graph model. In addition, the inference apparatus 100 may generate another probability graph model based on the inference result and may update the stored probability graph model using the other generated probability graph model, thereby achieving learning of the probability graph model. For example, the inference apparatus 100 may update the probability graph model based on one or more inference results thereby generating a learning probability graph model.

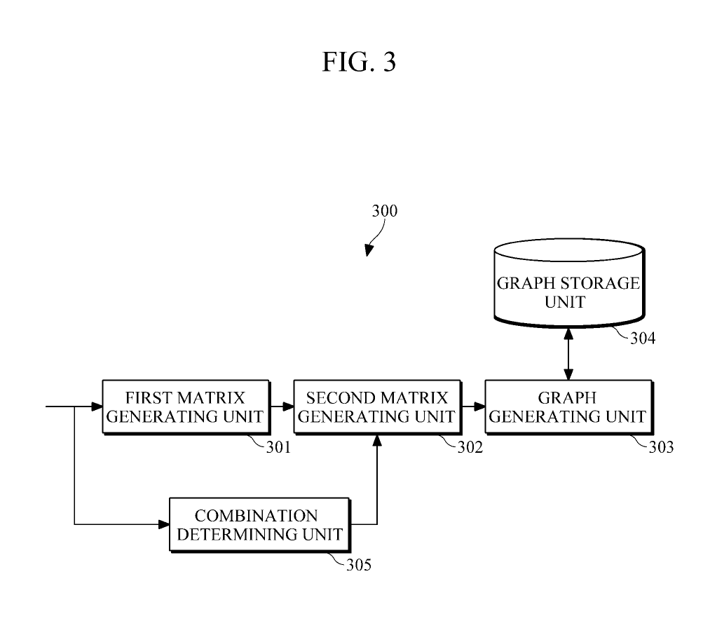

FIG. 3 illustrates an example of an apparatus for generating a probability graph model.

Referring to FIG. 3, apparatus 300 for generating a probability graph model includes a first matrix generating unit 301, a second matrix generating unit 302, a graph generating unit 303, a graph storage unit 304, and a combination determining unit 305.

The first matrix generating unit 301 may generate a first matrix. The first matrix may include stream data of independent variables including a plurality of input variables that correspond to context information and one or more output variables that correspond to an inference result. For example, the first matrix may be the stream data 203 shown in FIG. 2.

The second matrix generating unit 302 may generate a second matrix by selectively combining stream data in the first matrix. For example, the second matrix generating unit 302 may generate the second matrix using stream data of input variables from among the stream data of the first matrix except for stream data corresponding to output variables.

The second matrix generating unit 302 may generate the second matrix while increasing a combination degree, for example, from 1 to n. The second matrix generating unit 302 may indicate a predetermined region of the first matrix to generate first-degree combinations. For example, in FIG. 2, the second matrix generating unit 302 indicates a combination region 204 and generates first degree combination including b1, b2, b3, c1, c2, c3, d1, d2 and d3. The second matrix generating unit 302 may generate second-degree combinations by combining the first-degree combinations. For example, the second matrix generating unit 302 may generate second-degree combinations such as b1b2, b1b3, b1c1, . . . , b1d3, b2b3, b3c1, . . . , and d2d3 using the above example. The second matrix may include a first-degree combination and a second-degree combination.

The graph generating unit 303 may generate a probability graph model using the second matrix. For example, the graph generating unit 303 may calculate the probabilistic relationship between each data of the second matrix and the output variable of the first matrix and may generate a probability graph model based on the calculated result.

In addition, the graph generating unit 303 may store the generated probability graph model in the graph storage unit 304 or may update the probability graph model stored in the graph storage unit 304 using the generated probability graph model.

The combination determining unit 305 may determine a variable combination which is to be generated by the second matrix generating unit 302. In the example of FIG. 2, the amount of information of the variable A with respect to the variable X may be 10, and the amount of information of the variable B with respect to the variable X may be 20. This represents the recommendation of an application that is dependent of the location more than time in a probability graph model for recommending the optimum application. In this example, if the amount of information about a variable combination AB with respect to the variable X is 5, taking both of the time A and the location B into consideration may not be desirable when recommending the optimum application. As described herein, if a probability graph model is generated using the variable combination, the combination determining unit 305 may determine a variable combination that is to be generated, while avoiding generating unnecessary variable combinations.

Referring to FIG. 3, one or more of the first matrix generating unit 301, the second matrix generating unit 302, the graph generating unit 303, the graph storage unit 304, and the combination determining unit 305, may be combined into the same unit.

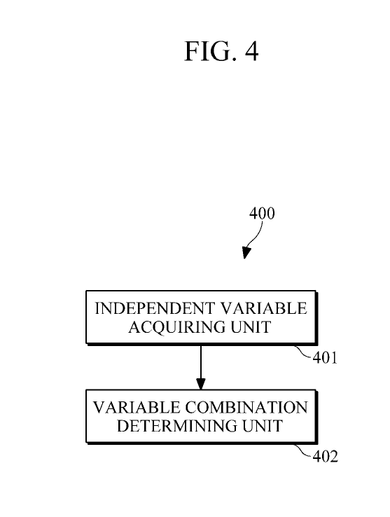

FIG. 4 illustrates an example of a combination determining unit.

Referring to FIG. 4, combination determination unit 400 includes an independent variable acquiring unit 401 and a variable combination determining unit 402.

The independent variable acquiring unit 401 may acquire a plurality of input variables corresponding to context information and one or more output variables corresponding to an inference result. For example, the independent variable acquiring unit 401 may receive the independent value 200 including the input variable 201 and the output variable 202 shown in FIG. 2.

The variable combination determining unit 402 may determine a desired variable combination that is to be generated, based on the amount of information of each of variable combinations with respect to the output variable. For example, the variable combination may be a combination of variables that are used to generate the second matrix by the second matrix generating unit 302 in FIG. 3. The amount of information of the variable combination may be based on the entropy of each input variable with respect to an output variable or the similarity in the conditional probability distribution of each input variable with respect to an output variable.

If the amount of information of the variable combination is estimated based on the entropy, the amount of information may be estimated using the fact that the amount of information is in inverse proportion to the entropy. For example, the lower the entropy that an input variable or a variable combination has, the higher the amount of information of the corresponding input variable or variable combination may be.

If the amount of information of the variable combination is estimated based on the similarity, the more similar the shape of the conditional probability distribution of each input variable included in a variable combination, the higher the amount of information of the corresponding variable combination may have.

For example, the variable combination determining unit 402 may calculate the entropy of each input variable with respect to an output variable, compare the calculated entropy with a threshold value, and select an input variable that has an entropy that is lower than the threshold value as an input variable for generation of variable combinations.

As another example, the variable combination determining unit 402 may determine a variable combination that is to be generated, by calculating a first entropy of each of the input variables with respect to an output variable, calculating a second entropy of each of the variable combinations of the input variables with respect to an output variable, and comparing the calculated first entropy with the calculated second entropy.

As another example, the variable combination determining unit 402 may determine a variable combination that is to be generated, based on the similarity between the conditional probability distributions of a first input variable and a second input variable with respect to an output variable. In this example, the similarity of the conditional probability distribution may be defined based on the similarity in shape of the probability distribution graph and/or based on the adjacency of the position of the maximum value of the probability distribution graph.

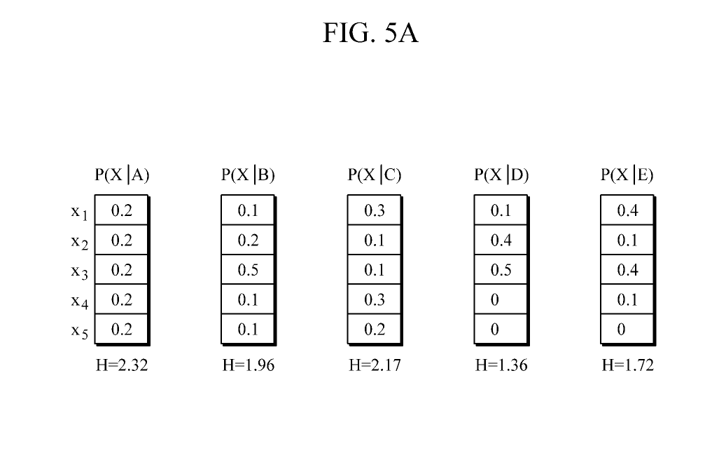

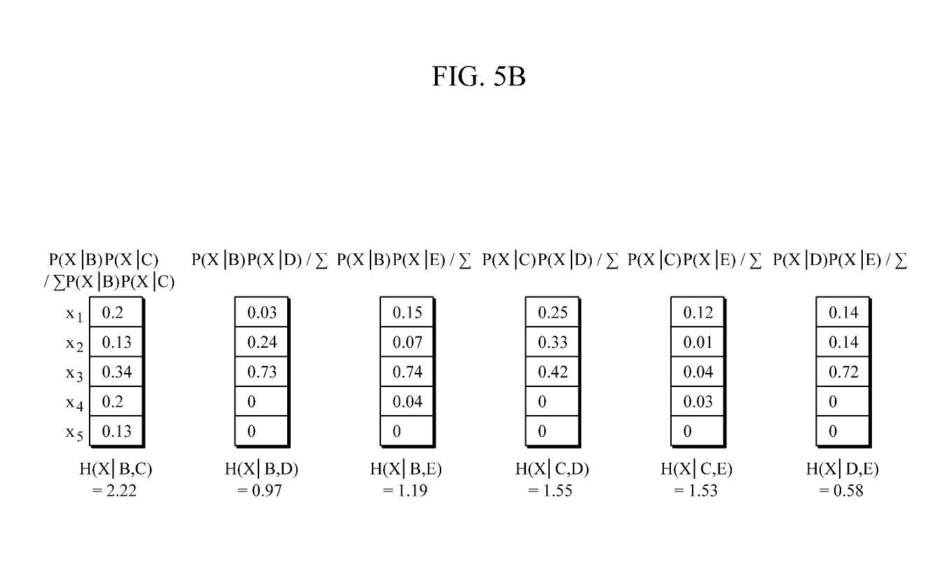

FIGS. 5A and 5B illustrate examples of estimating the amount of information.

Referring to FIGS. 4 and 5A, the variable combination determining unit 402 may generate a conditional probability distribution table about each input variable with respect to an output variable. For example, P(X|A) may represent the probability that a variable X occurs when a variable A is observed. For example, if the variable X denotes an application, the probability that an application x1 is executed when the variable A is observed is 0.2.

The variable combination determining unit 402 may calculate the entropy H of each input variable. The entropy may be calculated through equation 1 shown below.

$$H ( X ) = - {\sum }_{i}^{ } p ( {x}_{i} ) {log}_{2} p ( {x}_{i} ) \qquad [ Equation 1 ]$$

If the entropy of each input variable is calculated, the variable combination determining unit 402 may preliminarily select an input variable to be used for generating a variable combination, based on the calculated entropy. Described herein are two example methods for preliminarily selecting input variables.

In the first example method, a threshold value is set and an input variable that has an entropy lower than the threshold value is selected. For example, the threshold value may be 2.2. In the example of FIG. 5A, the entropy of the input variable A exceeds the threshold value and the entropy value of variables B, C, D, and E does not exceed the threshold value. Accordingly, the variable combination determining unit 402 may select input variables B, C, D and E except for the input variable A.

In the second example method, the threshold value is set, and a pair of test variables are generated. If the entropy of each input variable of the pair of test variables exceeds the threshold value, the input variables of the corresponding pair of test variables are excluded from generating the variable combination. For example, the threshold value may be 2.2. In the example of FIG. 5A, at least one of two input variables forming a pair of test variables is below the threshold value no matter which variables are combined to generate the two input variables. Accordingly, the variable combination determining unit 402 may selects all the input variables A, B, C, D, and E.

Referring to FIG. 5B, an example in which the input variable A is excluded according to the first method is further described.

Referring to FIGS. 4 and 5B, the variable combination determining unit 402 may generate variable combinations about the preliminarily selected input variables B, C, D and E, and may calculate the entropy each of the generated variable combinations. For example, the entropy may be calculated using Equation 1.

After the entropy of each of the generated variable combinations is calculated, the variable combination determining unit 402 may compare the entropy of a variable combination with the entropy of each input variable that is included in the variable combination, and may determine whether to select the variable combination for generating variable combinations.

For example, for the input variable B and the input variable C, the entropy of the variable B and the entropy of the variable C are 1.96 and 2.17, respectively, before combination, and the entropy of a variable combination of the input variable B and the input variable C is 2.22, after the combination. In this example, the variable combination of the input variable B and the input variable C has an entropy that increases in comparison to the original entropy of each of the input variable B and the input variable C. Accordingly, the variable combination determining unit 402 may exclude the variable combination BC for generating variable combinations.

As another example, for the input variable B and the input variable D, the entropy of the variable B and the entropy of the variable D are 1.96 and 1.36, respectively, before combination, and the entropy of a variable combination of the input variable B and the input variable D is 0.97, after the combination. In this example, the variable combination of the input variable B and the input variable D has an entropy which decreases in comparison to the original entropy of each of the input variable B and the input variable D. Accordingly, the variable combination determining unit 402 may select the variable combination BD for generating variable combinations.

As another example, for the input variable C and the input variable D, the entropy of the variable C and the entropy of the variable D are 2.17 and 1.36, respectively, before combination, and the entropy of a variable combination of the input variable C and the input variable D is 1.55, after the combination. In this example, the variable combination of the input variable C and the input variable D has an entropy that decreases in comparison to the original entropy of the input variable C, but increases in comparison to the original entropy of the input variable D. Accordingly, the variable combination determining unit 402 may exclude the variable combination CD for generating variable combinations.

As described herein, the variable combination determining unit 402 may define the amount of information of each input variable or each variable combination of input variables based on the entropy, and may exclude a predetermined variable combination that have an entropy value that does not increase, from variable combinations that are used for generating a probability graph model.

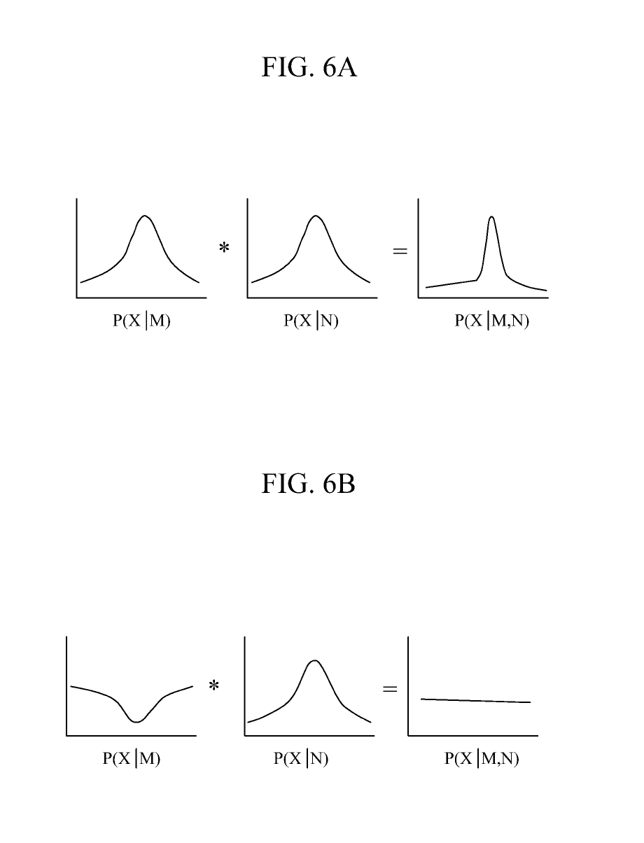

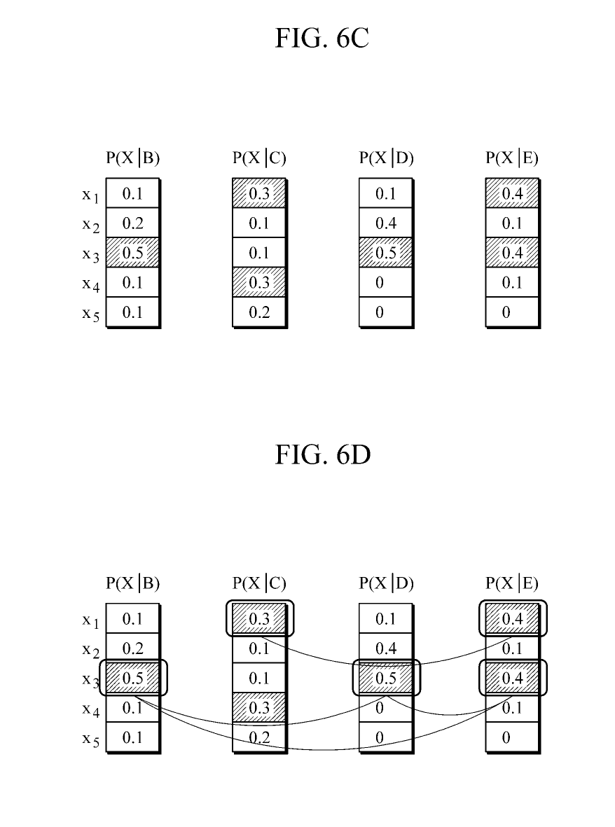

FIGS. 6A to 6D illustrate additional examples of estimating the amount of information.

If input variables are combined to a variable combination, whether the amount of information of the variable combination has increased or decreased, in comparison to the amount of information of each of the input variables forming the variable combination, may be determined by comparing the shape of the conditional probability distribution graph of each of the input variables.

Referring to FIG. 6A, if the shape of the probability distribution graph of a variable M with respect to a variable X is similar to that of a variable N with respect to the variable X, and if the variable M is combined to the variable N, the peak value of a graph is increased and the amount of information increases.

However, as shown in FIG. 6B, if the shape of the probability distribution graph of the variable M with respect to the variable X is different from that of the variable N with respect to the variable X, and if the variable M is combined to the variable N, the peak values cancel each other and the amount of information decreases.

Referring to FIGS. 4 and 6C, the variable combination determining unit 402 may detect the position of the maximum probability value from the conditional probability distribution table for each input variable with respect to an output value. In this example, the position of the maximum probability value of an input variable B corresponds to x3. The position of the maximum probability value of an input variable C corresponds to x1 and x4. The position of the maximum probability value of an input variable D corresponds to x1 and x3.

Referring to FIGS. 4 and 6D, the variable combination determining unit 402 may make a determination about combining input variables based on the detected position of the maximum probability value. For example, the input variable C and the input variable E have the maximum probability values at the position of x1. Accordingly, the input variable C and the input variable E may be used to generate a variable combination. However, the input variable B and the input variable C do not have their maximum probability values at a common position. Accordingly, the input variable B and the input variable C may be excluded from generating a variable combination.

This example has been described to have a single maximum probability value for the sake of convenience. However, it should be appreciated that a plurality of positions corresponding to a first maximum value and a second maximum value may be compared.

In addition to the examples described herein of estimating the amount of information using entropy or the position of a peak of the probability distribution graph, the amount of information may be estimated through a machine learning.

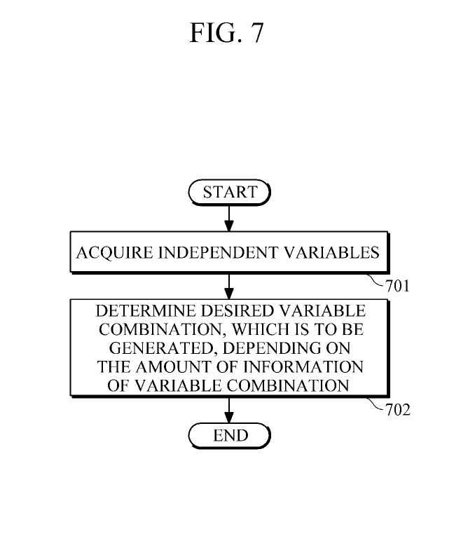

FIG. 7 illustrates an example of a method for determining a variable combination used to generate a probability graph model.

As shown in FIGS. 3 and 7, the combination determining unit 305 acquires independent variables (701). For example, the combination determining unit 305 may receive the independent variable 200 including the input variable 201 and the output variable 202. The input variable 201 may correspond to context information and the output variable 202 may be the inference result based on the context information.

After the independent variable is acquired, the combination determining unit 305 determines a variable combination that is to be generated based on the amount of information of a variable combination (702). For example, the combination determining unit 305 may determine the variable combination to be generated using the entropy as shown in FIGS. 5A and 5B. As another example, the combination determining unit 305 may determine the variable combination to be generated using the shape of the position of a peak of the conditional probability distribution graph as shown in FIGS. 6A to 6D.

According to various examples herein, in generating a probability graph model using a variable combination, the probability graph model may be generated using the variable combination except for a variable combination that has a small amount of information, thereby making the inference result appropriate to each situation and reducing the amount of computation used for generating the probability graph model.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for generating a probability graph model, the apparatus comprising:
an independent variable acquiring unit configured to acquire independent variables including a plurality of input variables corresponding to context information and an output variable corresponding to an inference result; and
a variable combination determining unit configured to determine a variable combination that is to be generated, based on an amount of information of each of the variable combinations with respect to the output value, in which the variable combination is defined based on combining of the input variables.

2. The apparatus of claim 1, further comprising:
a first matrix generating unit configured to generate a first matrix including stream data of the independent variables;
a second matrix generating unit configured to generate a second matrix by selectively combining stream data of first variables in the first matrix which are included in the determined variable combination; and
a graph generating unit configured to generate a probability graph model using the second matrix.

3. The apparatus of claim 1, wherein the variable combination determining unit determines the variable combination that is to be generated by calculating an entropy of each of the input variables with respect to the output variable and comparing the calculated entropy with a threshold value.

4. The apparatus of claim 1, wherein the variable combination determining unit determines the variable combination that is to be generated by calculating a first entropy of each of the input variables with respect to the output variable, calculating a second entropy of a variable combination of the input variables with respect to the output variable, and comparing the calculated first entropy with the calculated second entropy.

5. The apparatus of claim 1, wherein the variable combination determining unit determines the variable combination that is to be generated based on a similarity between a first conditional probability distribution of a first input variable with respect to the output variable and a second conditional probability distribution of a second input variable with respect to the output variable.

6. The apparatus of claim 5, wherein the variable combination determining unit determines the similarity based on a position of a maximum probability value of the first conditional probability distribution and a position of a maximum probability value of the second conditional probability distribution.

7. A method for determining a variable combination used to generate a probability graph model, the method comprising:
receiving independent variables including a plurality of input variables corresponding to context information and an output variable corresponding to an inference result; and
determining a variable combination that is to be generated, based on an amount of information of each of the variable combinations with respect to the output variable, in which the variable combination is defined based on combining of the input variables.

8. The method of claim 7, further comprising:
generating a first matrix including stream data of the independent variables;
generating a second matrix by selectively combining stream data of first variables in the first matrix which are included in the determined variable combination; and
generating a probability graph model by use of the second matrix.

9. The method of claim 7, wherein, during the determining of the variable combination that is to be generated, entropy of each of the input variables with respect to the output variable is calculated and the calculated entropy is compared with a threshold value.

10. The method of claim 7, wherein, during the determining of the variable combination that is to be generated, a first entropy of each of the input variables with respect to the output variable is calculated, a second entropy of a variable combinations of the input variables with respect to the output variable is calculated, and the calculated first entropy is compared with the calculated second entropy.

11. The method of claim 7, wherein, during the determining of the variable combination that is to be generated, the desired variable combination is determined based on a similarity between a first conditional probability distribution of a first input variable with respect to the output variable and a second conditional probability distribution of a second input variable with respect to the output variable.

12. The method of claim 11, wherein the variable combination that is to be generated is determined based a position of a maximum probability value of the first conditional probability distribution and a position of a maximum probability value of the second conditional probability distribution.

13. A terminal for inferring an application to be executed by a user of the terminal, the terminal comprising:
a receiver configured to receive input variables corresponding to context information about the terminal and an output variable corresponding to an inferred application recommended based on the context information; and
a determining unit configured to determine a combination of the input variables to be used in a probability graph model based on the amount of information of each corresponding variable combination.

14. The terminal of claim 13, further comprising a graph generator to generate the probability graph model based on the determined combination of input variables and to display the probability graph model.

15. The terminal of claim 13, wherein the determining unit determines a combination of input variables based on the entropy of each input variable with respect to the output variable.

16. The terminal of claim 13, wherein the determining unit determines a combination of input variables based on the similarity of a conditional probability distribution of each input variable with respect to the output variable.
